(19) United States
(12) Patent Application Publication
(10) Pub. No.: US 2008/0024686 A1
(43) Pub. Date: Jan. 31, 2008

(54) Audio Visual Surface Assembly

(76) Inventor: Philip Vafladis, Kent Town (AU)

Correspondence Address: Lumen IPS, 2345 Yale Street, 2nd Floor, Palo Alto, CA, 94306, US

(21) Appl. No.: 10/594,201

(22) PCT Filed: Mar. 24, 2005
(86) PCT No.: PCT/AU05/00418

§ 371 Date: Aug. 13, 2007

(30) Foreign Application Priority Data
Mar. 24, 2004 (AU) 2004901533

(51) Int. Cl. H04N 5/64

(52) U.S. Cl. 348/839

(57) ABSTRACT

There is disclosed an arrangement for a visual and/or audio presentation wherein two or more enclosure modules are mounted adjacent each other. The modules each contain an enclosure volume, within which an audio or other component may be housed. The arrangement also provides a flat or planar surface on which advertising or a visual presentation may be displayed. Furthermore, there is provided a channel behind the planar surf ace, through which cables or the like may be laid.

This invention relates to audio visual presentation arrangements and in particular wall-mounted arrangements.

### BACKGROUND

The enjoyment of audio and visual entertainment, in particular pre-recorded or broadcast audio and visual entertainment is a very personal experience. It is therefore expected that there is a wide variety of audio and visual arrangements available to deliver that experience.

A simple arrangement may comprise a compact disc player connected to left and right speakers through an amplifier all located on a shelf typically arranged facing the listener. A simple video display arrangement may comprise a television connected to a video cassette or digital versatile disc player with audio being reproduced by speakers associated with the television.

At another end of an arrangement scale is a full cinematic experience which is provided by a many metres wide 1.85:1 or 2.35:1 aspect ratio screen and banks of high power amplifiers and speakers positioned behind the screen. Projection of the image is done from a distance over the heads of the viewers/listeners.

Such is the sophistication of the electronics, associated optics and quality of speakers available to consumers, that a very effective cinematic experience can now be replicated in home theatres and business/commercial environments.

Audio visual arrangements vary for many reasons including cost, space availability, aesthetics, technical excellence, personal wants, and business needs etc. The acoustic qualities of the environment are also important. It is not uncommon for drapes, furniture fabric, carpeting and sometimes passive and active sound reflection and absorption devices to be strategically located within a room to enhance the listening experience.

The wall upon which the image is projected or upon which an active video screen (such as plasma or liquid crystal display) is mounted, typically needs to be prepared. Speakers, if they are to be mounted on the wall may need to have channels chased into them and once the speaker wiring is installed the channels are restored to a presentable finish.

In the case of a projection screen, specialist suppliers can provide a stiff and preferably light framework over which a sheet of suitable reflective material is fitted. Alternatively, there are roll-up screens, some of which are motorised and remotely controllable.

As will be apparent from the very brief description of current arrangements there are many individual elements that make up an audio visual arrangement and the way that they all come together requires the skill of many highly trained individuals.

It is an aim of the invention described herein to offer a further alternative arrangement, one that minimises or eliminates some of the problems and complexities of creating an audio visual presentation arrangement in a home, office or commercial environment. The arrangement disclosed herein may also be a cheaper, more convenient and rapidly installed system than the alternatives currently available, while still allowing creative aesthetic treatment to suit its surrounds.

### BRIEF DESCRIPTION OF THE INVENTION

In a broad aspect of the invention an arrangement for a sound and/or visual presentation includes at least two enclosure modules for housing one or more audio or visual components, the modules adapted for mounting on a mounting surface adjacent one another, wherein the front of each module when mounted defines a facing plane and the adjacent sides of respective modules are shaped to match each other's facing planes an to provide a channel behind said facing surfaces.

Preferably, the channel is provided between said adjacent sides.

In a further aspect of the invention said module has four solid wall surfaces that rearwardly converge inwardly from the facing plane to a common substantially planar solid minor surface to form an enclosure behind said facing plane.

In a yet further aspect of the invention the facing plane lies substantially flush with a substantially planar visible surface of a said visual component (video monitor screen).

In another aspect of the invention said enclosure houses one or more of an audio component being a sound driver (speaker); sound absorber; sound diffuser; active audio equipment (amplifier, cross-over, etc).

The facing plane may be defined by any features of the module, for instance a substantially planar major facing surface may be provided. However, preferably the facing plane is defined simply by the front edges of the side walls. Furthermore, in some embodiments of the invention, the facing plane is covered with a fabric.

Preferably, said fabric is of such a character that it is suitable for projection of visual images and/or is acoustically transmissive.

In accordance with the previous aspects said fabric can be located over two or more adjacent enclosure modules to form a single fabric surface over the facing plane.

In accordance with the previous aspects one or more layers of fabric of the same or different characteristic cover said facing plane.

In a further aspect of the invention the arrangement further includes said minor surface being adapted for mounting on the mounting surface.

In a yet further aspect of the invention the arrangement is configured such that two opposed solid wall surfaces of the module are oriented at 90° to each other, thus said enclosure module can be mounted to surfaces at 90° to each other (room corner).

Throughout this specification unless the context requires otherwise, the words “comprise” and “include” and variations such as “comprising” and “including” will be understood to imply the inclusion of the stated integer or group of integers but not the exclusion of any other integer or group of integers. Further, the use of particular examples of alternatives is not an indication or admission that those examples are part of a common knowledge of those skilled in the art.

Furthermore, the term “enclosure” as used in this specification is not limited to those embodiments where a space is fully enclosed on all sides, but refers instead to providing a space in which an object may be housed, regardless of whether a portion of the enclosure is open.

Specific embodiments of the invention will now be described in some further detail with reference to and as illustrated in the accompanying figures. These embodiments are illustrative, and not meant to be restrictive of the scope of the invention. Suggestions and descriptions of other embodiments may be included within the scope of the invention, but they may not be illustrated in the accompanying figures or alternatively features of the invention may be shown in the figures but not described in the specification.

### BRIEF DESCRIPTION OF THE FIGURES

FIG. 1 depicts a front perspective view of a single module;

FIG. 2 depicts a rear view of a single module;

FIG. 3 depicts a front view of a single module with diffuser infill;

FIG. 4 depicts a cross-sectional view along line A-A of FIG. 1 showing an absorber infill;

FIG. 5 depicts a cross-sectional view along line B-B of FIG. 3 showing a diffuser infill;

FIG. 6 depicts a front view of a single module having a diffuser infill;

FIG. 7 depicts a front view of a single module having a driver (speaker) infill;

FIG. 8a depicts a section view of a single module having a driver infill;

FIG. 8b depicts a section view of a single module having a small flat monitor infill

FIG. 8c depicts a section view of a single module having an electronic device infill;

FIG. 9 depicts a vertical wall surface having an array of modules fitted thereto;

FIG. 10 depicts the arrangement of FIG. 8 with a single material cover over all of those modules;

FIG. 11 depicts the module installed in a corner;

FIG. 12 depicts a presentation arrangement including a video display surrounded by an array of modules;

FIG. 13 depicts one possible mounting arrangement for the mounting of an array of modules; and

FIG. 14 depicts one embodiment of a mounting arrangement of an array of modules showing a channel space behind the modules.

### DETAILED DESCRIPTION OF EMBODIMENTS OF THE INVENTION

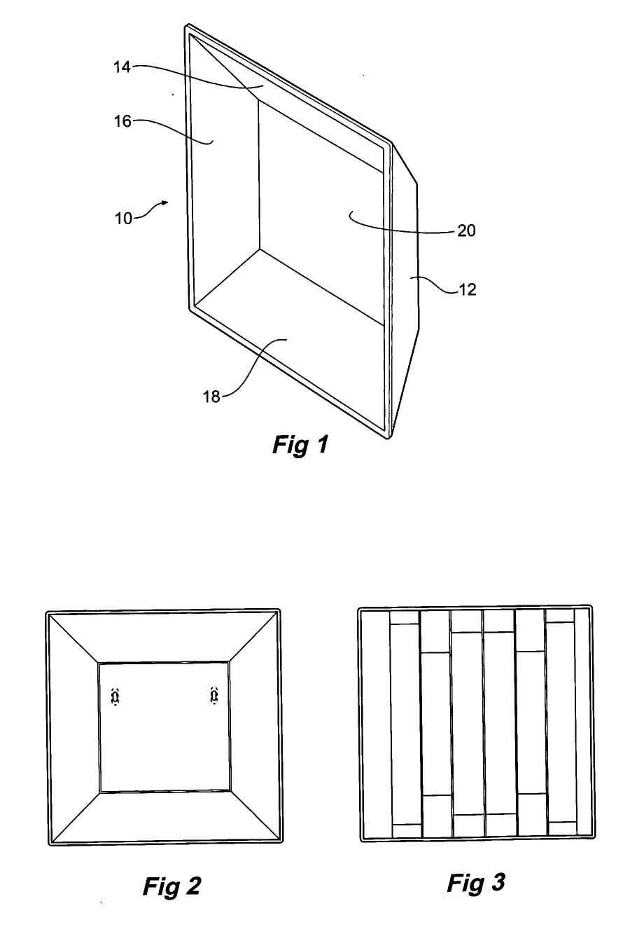

The perspective view of an enclosure module 10 is depicted in FIG. 1. In this embodiment the the enclosure module 10 has four side walls 12, 14, 16 and 18 and a rear planar wall 20 (refer also to FIGS. 2 and 3) which define an enclosure volume as shown.

Preferably, the enclosure module 10 is be made from injection moulded plastic to keep costs to a minimum once the moulding costs are amortised, but a variety of other materials could be used to form the enclosure module such as for example MDF or wood. The latter materials however may require greater labour to machine and construct the module.

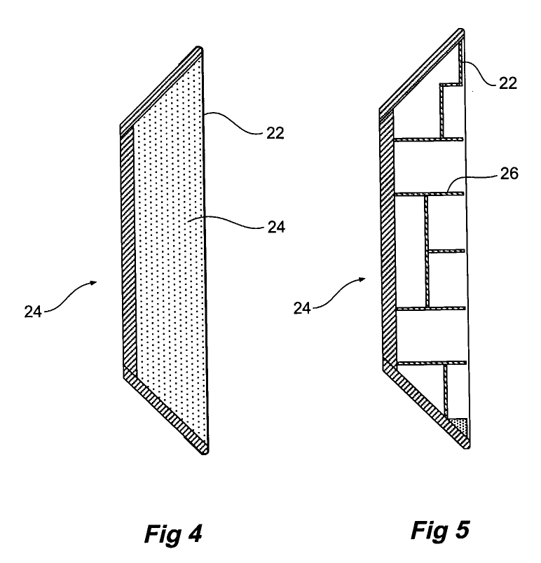

The front of the enclosure module 10 is open (FIG. 1) and the periphery of the enclosure opening is a frame which defines a facing plane over which a covering 22 (not shown) is fitted (see FIG. 4) to provide a facing surface. The facing surface thus created is the visible part of the then created enclosure module 10.

Preferably, the covering is of an aesthetically acceptable material and typically will comprise a cloth of suitable colour. For the sake of consistency, each module will be covered in the same material but that may vary for aesthetic requirements and since the module will also typically have an audio process associated with it (speaker housing, sound absorber and/or diffuser), the material chosen will have acceptable sound transmission characteristics. That is, it will generally have a very low sound attenuation and distortion characteristic, if any.

However, compromises may be required and some cloth material may be better for printing upon or for reflection of projected light images. In the case of a printing requirement, images of an advertising or aesthetic nature can be printed on the material either before fitment or after fitment. Alternatively, or in addition to the above, the cloth may be printed with a single colour that conforms to a known colour standard. Therefore, the cloth colour can be made to better match or complement its environment.

Details of presentation arrangements incorporating one or more of those aspects will be described later in the specification.

FIG. 4 also depicts a cross-sectional view of an enclosure module that contains audio frequency absorbent material 24 so that the module will absorb sound energy that enters via the cloth covered facing surface. The module or an array of such modules can be located along a wall and possibly on or within ceiling surfaces so as to adjust the acoustic properties of a room. The dimensions of the module can be such that one or more of them can be readily accommodated in standard ceiling panel frameworks.

The absorbent material 24 is typically foam and audio frequency absorbency characteristics are largely determined by the density of the foam. This characteristic can be controlled at the time of manufacture of the foam used in the module as required. Other absorbent material can be used such as for example glass fibres.

FIG. 5 depicts a cross-sectional view of a module that contains an audio frequency diffuser 26 so that the module will diffuse sound energy that enters via the cloth covered facing surface. The module or an array of such modules can be located along walls and possibly ceiling surfaces so as to adjust the acoustic properties of the room.

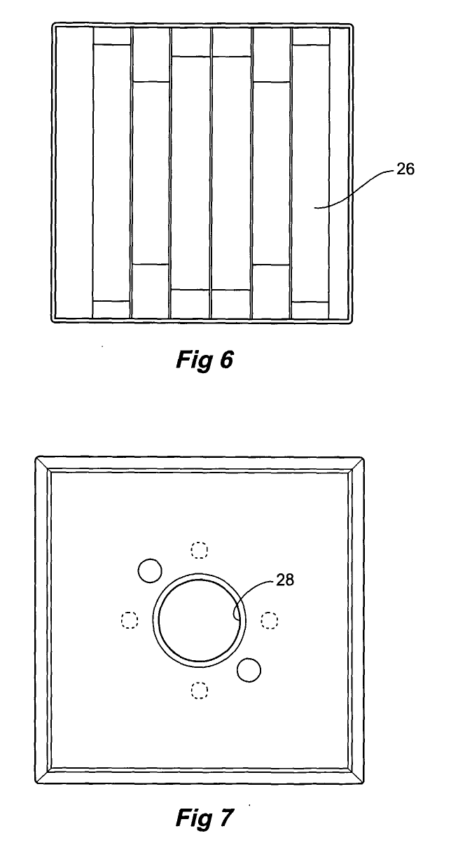

The diffuser is typically formed by an array of rectangular cavities as depicted in FIG. 6, the length and volume of which are designed to redistribute the impinging sound in a manner other than that which would be created by a flat surface. The wall of the cavities has a predetermined reflectance. Although it is likely that the array of cavities will be the same for most modules, it is possible for the array of cavities to differ as diffusion characteristics may also need to differ. It is preferable that the array of cavities is itself an injection moulded plastics element adapted for easy fitment and if necessary engagement with the interior of the module.

It is also possible for one module to contain both reflector and absorber elements or an audio driver and reflector and/or absorber elements arranged to suit a particular acoustic requirement.

FIG. 7 depicts a module having an audio driver (speaker) 28 located centrally of the enclosure. Alternative audio driver configurations including multiple drivers in the same cabinet are possible. Various loading techniques could be applied to the drivers to achieve desired results eg. reflex ports. Not shown but likely to also be used is a sound absorbent material surrounding the speaker. However, the desired audio characteristics of the speaker and enclosure module as a whole will determine whether audio absorbent material or sound reinforcing cavities are used to create the desired audio characteristics.

A board can be fixed to the front of the frame to which the driver is attached.

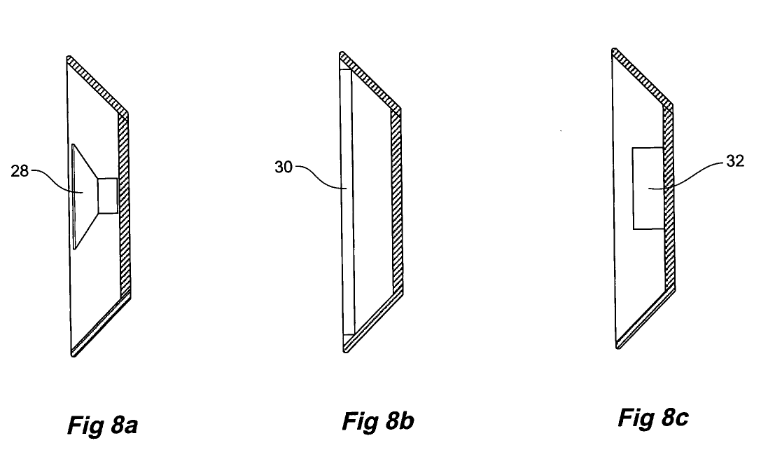

FIG. 8a depicts a cross-sectional view of a module housing a speaker 28.

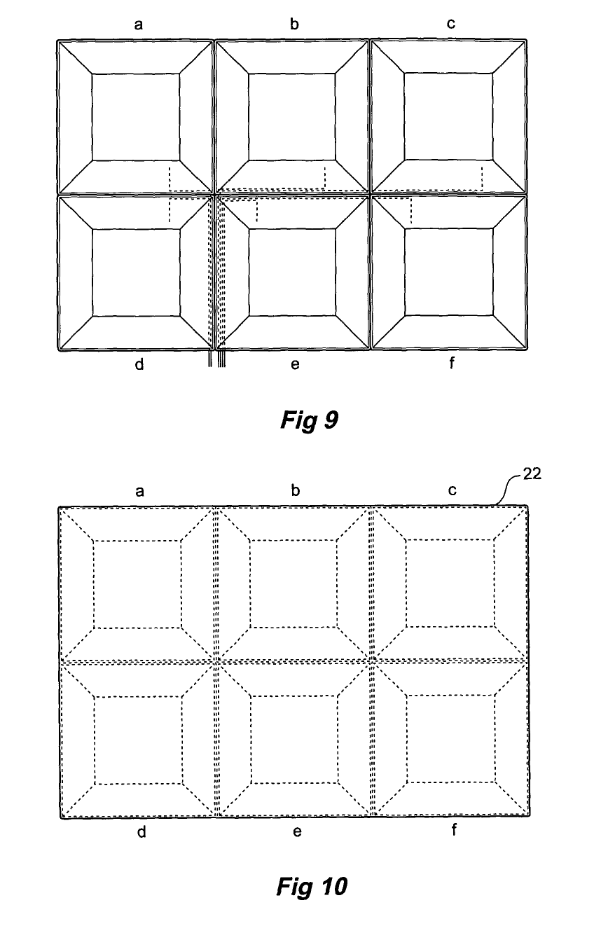

FIG. 8b depicts a cross-sectional view of a module having a visual presentation device in the form of a flat panel display 30. Plasma and liquid crystal display flat panels are suitable but other types may be accommodated if desired and adequate space is available. When an array of modules is used on the mounting surface (see FIGS. 9 and 12) one or more panels may be omitted from the array and a display device bracket fixed to the mounting surface. The bracket can be arranged so that the surface of the video display is located flush or proud of the array surface.

FIG. 8c depicts a cross-sectional view of a module having an electronic device 32 located inside the module.

FIG. 9 depicts a vertical mounting surface having an array of modules fitted thereto. As will be apparent one or more of the modules can be of the type described above. By way of example, a sound wall can be created by installing a driver in two opposed modules a and c as well as matching drivers in modules d and f while modules b and e can be fitted with sound absorbent material. The wiring shown (dotted lines to each module) is merely indicative of the route such wiring could take.

FIG. 10 depicts an array of modules (dotted lines) covered with a single piece of cloth 22 which provides a seamless planar surface over all of the modules. The size of the surface can be arranged so that a projected image is of an adequate proportion and size for use as a projection screen.

The cloth used on the external surface is of suitable characteristics to adequately reflect impinging light from a digital projector or the like. Such characteristics may depend on the colour, weave or knitted tightness, material (synthetic, etc) and others all of which can be ordered for any particular situation.

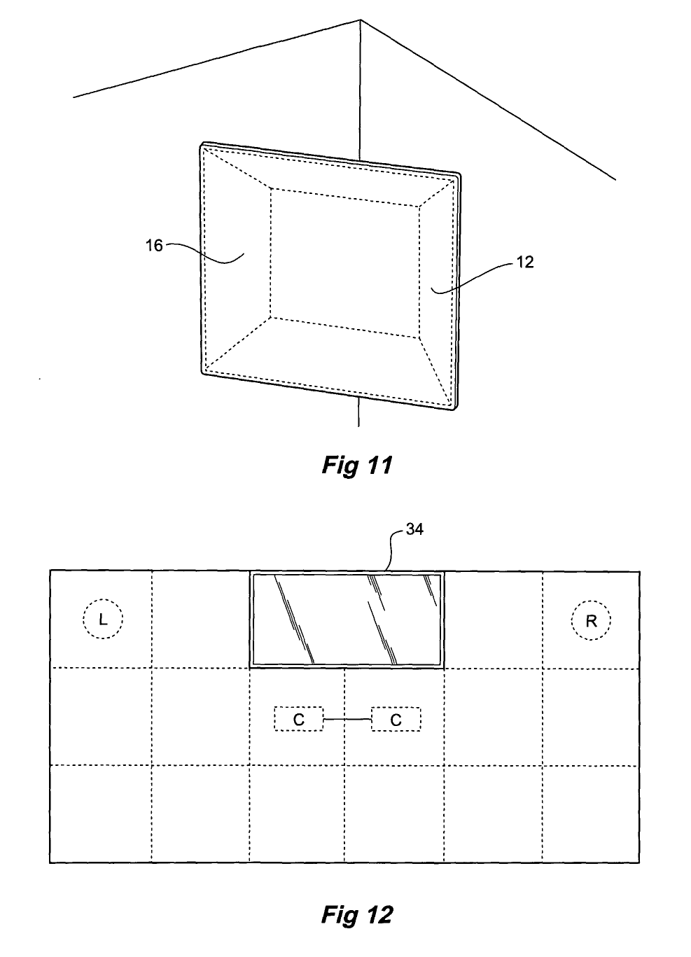

FIG. 11 depicts the module installed in a corner of a room. As the angle of the opposed side walls 12 and 16 (refer FIG. 1 as well) are set at 45°to the facing plane of the module, meaning that these surfaces are at 90° to each other. The same mounting arrangement can be done at the junction of a wall and a ceiling. Therefore, the walls 12 and 16 of the module are able to abut adjacent the wall surfaces of a typical room at its corner which are also at 90° to each other.

A stacked array of such modules could occupy a floor to ceiling or any portion thereof and room for cabling can be laid behind the modules. Such cabling could supply mains power for active audio or video components or audio signal wiring to active or passive components contained within one or more of the modules.

FIG. 12 depicts an array of modules located about a video display device 34. In this example the video display device is a plasma display which is mounted in the standard manner on a wall surface. Locating the plurality of modules about the display and arranging the front display surface of the visual display to lie flush with the facing plane of the modules, provides an acceptable aesthetic arrangement. Other arrangements may also be acceptable. The mounting surface may be uneven or curved and the modules can be arranged appropriately.

If the dimensions of the screen are such that there is a gap between the periphery of the screen and the nearest module, the gap can be filled by an additional frame covered with the same material as that used on the modules. As before, the modules may enclose one or more of the various elements previously described.

In the arrangement depicted in FIG. 12, a home cinema arrangement would have a front left and right driver (speakers) in modules to the right and left of the screen, while the centre channel driver (speaker) would be in a module centred in the array and below or above the screen as desired or as acoustically required.

Either a diffuser or an absorber or combinations of these modules can be used in the remaining modules as required and may include a module having both these types of in fills.

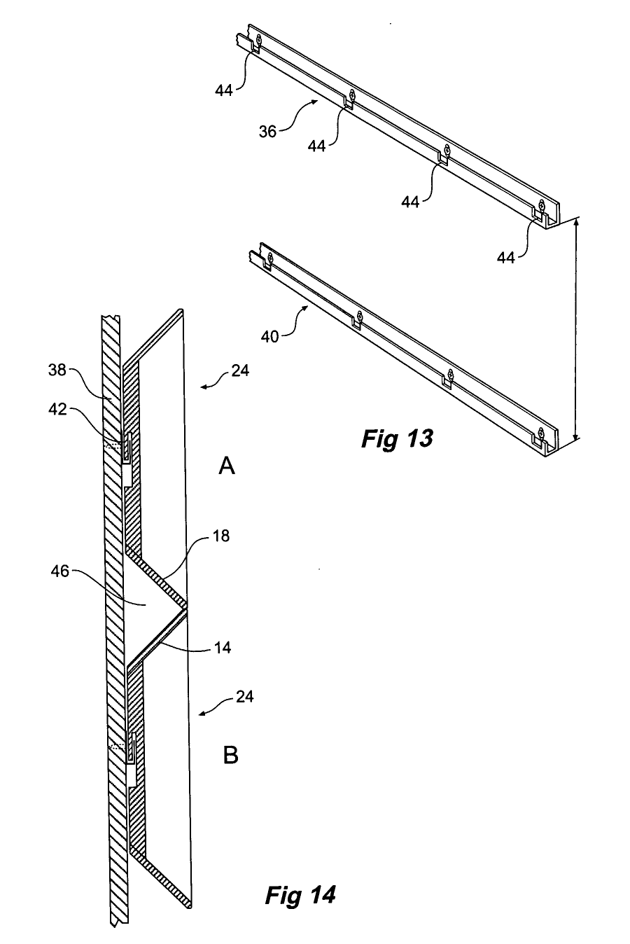

FIG. 13 depicts an embodiment of a mounting arrangement for one, two or more laterally adjacent modules. In this embodiment a upper rail 36 is used to support a first row of adjacent modules. A second rail 40 spaced below the first rail 36 is used for mounting an additional row of adjacent modules if the spacing between rails is appropriate.

In a preferred arrangement the rail 36 is of generally U-shape wherein one side of the U is longer than the other. The longer side is horizontally positioned and fixed against a mounting surface 38, generally a wall (see FIG. 14), but it could be a temporary panel or other surface upon which to locate an audio/visual arrangement.

The shorter side of the U-shaped rail is sized and shaped so as to engage a lip, groove, or other means 42 on the rear minor surface of the module 24. The engagement is such that the module remains upright and firmly engaged with the rail, against downward and outward movement. The rail is shaped so that modules can slide along it to achieve a final lateral location, for example to align with other non-module elements and other adjacent modules. Once the final location of a module is determined lateral fixing means (not shown) can be employed to fix the lateral position of the module or modules with respect to the rail.

In one embodiment the lateral fixing means may comprise a clamp applied between the rail and an outermost module/s of each row of modules. In another embodiment the lateral fixing means may be as simple as an engagement groove or tang 44 in the shorter side of the rail that matches a reciprocal tang or groove on the module (not shown). The tang and groove arrangement is a simple arrangement as no tools will be required to achieve the fixing of a module along the rail, but such an arrangement would not allow unhindered and infinite positional adjustment of the module along the rail. Many other ways of fixing the module to such a rail will be readily apparent. There will of course be many other ways of mounting a module to a wall not including a rail.

One such fixing arrangement could include directly fixing each module to the mounting surface and the rear view shown in FIG. 2 of a module shows two apertures used for hanging the module.

A further requirement of a rail mounting arrangement is that once a module is engaged with the rail, there should preferably be no substantial gaps between the rear minor surface of the module and the mounting surface.

With the module preferably lying flush with the mounting surface, the facing plane of the module should preferably be parallel with the mounting surface providing an acceptable aesthetic appearance. In some situations when the mounting surface is curved or uneven the mounting arrangement will need to be adapted to suit.

During the process of installing an audio/visual arrangement when more than one row of modules is to be located on a mounting surface, any subsequent rail can be located at an appropriate distance above or below the previous rail.

Once the subsequent rail is appropriately fixed to the mounting surface, additional modules of the array can be positioned along the second rail, so that the respective lower and upper edges of modules in the array will abut to form a substantially continuous front panel surface to the array as depicted in side view in FIG. 14.

FIG. 14 also depicts a channel 46 located behind the modules formed at the rear by the mounting surface 32 and side walls 18 and 14 of respective upper and lower modules A and B. The channels thus formed run horizontally and parallel with the rails 36 and 40.

Another channel (not shown in FIG. 14) is formed between the modules that run vertically. This channel is formed by the mounting surface 32 and the side walls 16 and 20 of horizontally sideways adjacent modules.

All the channels provide adequate space for the subsequent running or pre-wired runs of cable from their source to the various elements in the various modules.

Access for the wiring to each module is made when required by drilling an appropriate aperture into a wall of the module, as preferably the modules are constructed in a solid form without pre-drilled apertures for wiring. Alternatively, connection terminals may be made available on one or more of the walls of the module for the quick and secure fixing of prepared cable ends.

If the modules are arranged to be adjacent the floor or ceiling, then cables can be readily introduced unseen into any of the channels which are all in communication with each other.

Alternatively, one exit aperture from internal of the mounting structure (wall) to a location coincident with a channel between modules allows distribution of some or all of the wiring from that one or even more apertures to all of the modules via one or more of the channels, this also allows the physically separate location of mains and signal carrying wires through different channels.

Such an arrangement is beneficial aesthetically as none or very little of the wiring will be visible to a listener or observer of the audio/visual arrangement and technically as separation of different types of wiring from one another is preferable.

The arrangement is modular in that the different features of each module can be combined as required or desired on one or more mounting surfaces. The surfaces will typically be walls of an audio/visual entertainment room but the ease of fitment of the modules and their self contained nature allows them to be used on temporary wall or partition structures such as are typically constructed in demonstration spaces on free standing frames. The modules can even be fitted on to the ceiling of rooms having changeable ceiling files or made a permanent fixture by fitment to the existing ceiling.

Inherent in the design of an array of modules is the provision of multiple channels and thus the ability to keep wiring hidden from sight while providing easily accessible spaces for adjustment or rewiring, as each module can be moved, removed and replaced as required. These channels may be provided between the modules as shown in the above preferred embodiment, or may be provided by indentations in the rear minor surface.

It will be appreciated by those skilled in the art that the invention is not restricted in its use to a particular application described. Neither is the present invention restricted in its preferred embodiment with regard to the particular elements and/or features described or depicted herein. It will be appreciated that various modifications can be made without departing from the principles of the invention. Therefore, the invention should be understood to include all such modifications within its scope.

The claims defining the invention are as follows:

1. An arrangement for sound and/or visual presentation including at least two enclosure modules adapted for housing one or more audio or visual components, the modules also adapted for mounting on a mounting surface adjacent one another, wherein the front of each module when mounted defines a facing plane and the adjacent sides of respective modules are shaped to match each other's facing planes and to provide a channel behind said facing plane.

2. An arrangement as in claim 1, wherein the channel is provided between said adjacent sides.

3. An arrangement as in claim 2, wherein each module has four solid wall surfaces that rearwardly converge inwardly from said facing plane.

4. An arrangement as in claim 3, wherein the four solid wall surfaces converge to a common substantially planar solid minor surface thereby forming an enclosure behind said facing plane.

5. An arrangement as in claim 3, wherein the facing plane lies substantially flush with the substantially planar visible surface of a visual component.

6. An arrangement as in claim 1, wherein at least one enclosure module houses an audio component.

7. An arrangement as in claim 6, wherein the audio component is a sound driver.

8. An arrangement as in claim 6, wherein the audio component is an active audio component.

9. An arrangement as in claim 1, wherein at least one enclosure module houses a sound absorber.

10. An arrangement as in claim 1, wherein at least one enclosure module houses a sound diffuser.

11. An arrangement as in claim 3, wherein the facing plane is covered by a fabric.

12. An arrangement as in claim 11, wherein the fabric is of a suitable character for projection of visual images onto the fabric and refection there from.

13. An arrangement as in claim 11, wherein the fabric is acoustically transmissive.

14. An arrangement as in claim 11, wherein the fabric covers two or more adjacent enclosure modules thereby forming a single planar surface.

15. An arrangement as in claim 11, wherein more than one layer of fabric covers the facing plane.

16. An arrangement as in claim 15, wherein the fabric in one layer has a different characteristic to the fabric in another layer.

17. An arrangement as in claim 4, wherein the minor surface is adapted for mounting on the mounting surface.

18. An arrangement as in claim 3, wherein two opposed solid wall surfaces are oriented at 90 degrees to each other, thereby allowing the enclosure module to be mounted to a mounting surface with portions thereof at 90 degrees to each other, such as a room corner.

19. An arrangement as in claim 14, wherein the fabric is of a suitable character for projection of visual images onto said fabric and refection there from.
